(19) United States
(12) Patent Application Publication
(10) Pub. No.: US 2005/0281919 A1
(43) Pub. Date: Dec. 22, 2005

(54) Frozen food with seasoning liquid

(75) Inventors: Masayuki Ueno, Oura-gun (JP); Chieko Kogure, Oura-gun (JP); Mitsuhiro Kakuta, Oura-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AJINOMOTO CO. INC, Tokyo (JP)

(21) Appl. No.: 11/149,222

(22) Filed: Jun. 10, 2005

(30) Foreign Application Priority Data
Jun. 11, 2004 (JP) 2004-173570

(51) Int. Cl. A23G 1/00

(52) U.S. Cl. 426/100

(57) ABSTRACT

Frozen foods which contain a seasoning liquid, having a specified viscosity, and a main food arranged in a container in that order minimize the migration of water from the seasoning liquid to the main food (e.g., noodles and boiled rice), afford cooked foods which have excellent appearance when plated on a dish, are capable of saving a person time for conducting miscellaneous affairs after the food is heated and cooked, and do not entail a high packaging cost. The seasoning liquid is arranged in a container of a predetermined shape, and then a main food is placed thereon in the mentioned order, so as to prevent the seasoning liquid and main food from being united as one when the food is manufactured and thawed.

### CROSS REFERENCES TO RELATED APPLICATIONS

This application claims priority to Japanese Patent Application No. 173570/2004, filed on Jun. 11, 2004, which is incorporated herein by reference in its entirety.

### BACKGROUND OF THE INVENTION

1. Field of the Invention

The present invention relates to frozen foods with a seasoning liquid and a method of manufacturing the same. More particularly, the present invention relates to frozen foods with a seasoning liquid, which may be suitably thawed and thermally cooked in a microwave oven, and a method of manufacturing the same. The present invention further relates to a method of preparing a cooked food from such a frozen food and the frozen foods so produced.

### DISCUSSION OF THE BACKGROUND

Frozen foods with a seasoning liquid, such as chow mein dressed with liquid starch, the Chinese dish of fried rice with eggs, shrimps, etc. dressed with liquid starch, and the like are manufactured as articles of commerce, circulated, thawed and cooked by being heated on a microwave oven, and then eaten.

Frozen spaghetti sealed in a container in which an upper surface as a whole of a lump of molded, boiled and frozen spaghetti is dressed with frozen sauce and housed in a packaging container is known (see, JP-A-07-194326).

JP-A-07-194326 relates to the techniques for preventing the occurrence of the local overheating of frozen spaghetti in a microwave oven, characterized in that, when frozen sauce-dressed spaghetti is thermally cooked on a microwave oven, the frozen sauce melts and penetrates into the spaghetti thereunder. According to the disclosed invention, forming two layers in which the sauce and spaghetti are united closely as one with at least a whole upper surface of the lump of spaghetti being dressed with the frozen sauce layer is an essential structural requirement for the purpose of preventing the occurrence of local heating of the spaghetti.

According to JP-A-07-194326, the seasoning liquid and spaghetti, i.e., a main food are united as one and packed in a container, and the migration of water from the seasoning liquid to the main food occurs, so that the feeling of eating (texture) the food is spoiled. When the seasoning liquid, such as meat sauce penetrates into the spaghetti during the cooking thereof, the seasoning liquid does not gather on the spaghetti, so that the external appearance of the spaghetti at the time of dishing of the same is deteriorated in some cases.

Frozen foods in which a main food material is inserted in a bottom portion of a container with an upper surface of the main food material covered with a sheet type food material and on which a liquid auxiliary food material is placed, for the purpose of obtaining a frozen food of an excellent appearance without spoiling the feeling of eating (texture) and the taste intrinsic to the main food material during the heating thereof in and on a microwave oven and oven are also known (see, JP-A-10-66525).

Since this frozen food has a sheet type food material set therein, the manufacturing steps and manufacturing cost are excessive. Moreover, due to the sheet type food material added, it is difficult to provide the taste and the feeling of eating (texture) intrinsic to the frozen food.

Frozen foods in which a main food and a seasoning liquid are packaged and frozen separately are sold. However, in this mode of article of commerce, the packaging material cost and manufacturing cost are also excessive. Moreover, since the food and seasoning liquid are packaged separately, the cooking thereof requires long time.

Thus, there remains for frozen foods which do not suffer from the above-mentioned drawbacks.

### SUMMARY OF THE INVENTION

Accordingly, it is one object of the present invention to provide novel frozen foods.

It is another object of the present invention to provide novel frozen foods with a seasoning liquid, capable of reducing the migration of water from the seasoning liquid to any noodle and/or rice which contained in the main food.

It is another object of the present invention to provide novel frozen foods which exhibit an excellent appearance when dished up.

It is another object of the present invention to provide novel frozen foods which save a consumer labor during the serving and eating of the resulting thermally cooked food.

It is another object of the present invention to provide novel frozen foods which requiring little packaging material cost.

It is another object of the present invention to provide novel methods for manufacturing such a frozen food.

It is another object of the present invention to provide novel methods of preparing a cooked food from such a frozen food.

It is another object of the present invention to provide novel cooked foods which are prepared from such a frozen food.

These and other objects, which will become apparent during the following detailed description, have been achieved by the inventors' discovery that the problems of the prior frozen foods discussed above could be solved by arranging in a container of a predetermined shape a seasoning liquid the viscosity of which was controlled and a main food thereon in the mentioned order so as to prevent the seasoning liquid and main food from being united as one during the manufacturing and thawing the same.

Thus, the present invention provides:
(1) a frozen food comprising a seasoning liquid and a main food arranged in the mentioned order in a container, wherein said seasoning liquid has a viscosity as measured with a C-type viscometer at 70° C. being 1000 to 8000 cP, and wherein said seasoning liquid and said main food are frozen with said seasoning liquid and said main food not wholly but partially contacting each other.
(2) a frozen food according to (1), further comprising at least one additional ingredient provided between said seasoning liquid and said main food.
(3) a frozen food according to (2), wherein said seasoning liquid and said at least one additional ingredient are mixed with each other.
(4) a frozen food according to any one of (1) to (3), wherein said main food has a bottom surface area and said main food also has portions of said bottom surface area which contact said seasoning liquid, and wherein said bottom surface area of said main food is larger than the portions of said bottom surface which contact said seasoning liquid.
(5) a frozen food according to any one of (1) to (4), wherein said container has two levels of depth.
(6) a method of manufacturing a frozen food according to any one of (1) to (5), wherein said method comprises:
(a) inserting a seasoning liquid into a container, to obtain a container containing a seasoning liquid;
(b) inserting a main food into said container containing a seasoning liquid, to obtain a container containing a seasoning liquid and a main food; and
(c) freezing said seasoning liquid and said main food in said container containing a seasoning liquid and a main food.
(7) a method of preparing a cooked food, said method comprising:
(a) thawing a frozen food according to any one of (1) to (5) while maintaining the arrangement of the frozen food in said container; and
(b) inverting the arrangement of said seasoning liquid and said main food, to obtain a dished up food in which said seasoning liquid is on top of said main food.

According to the present invention, a frozen food which preserves the good feeling of eating (the good texture) of the main food even after the food has been thermally cooked can be provided.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 is a drawing showing an embodiment of the present invention in which a container has a two-stage depth, in which the reference numerals have the following meanings:

1 is a container having a two-stage depth;

2 is a seasoning liquid;

3 is a main food; and

4 is a portion at which the seasoning liquid and the main food contact each other not wholly but only partially.

### DETAILED DESCRIPTION OF THE PREFERRED EMBODIMENTS

Thus, in a first embodiment, the present invention provides novel frozen foods which comprise a seasoning liquid and a main food.

The seasoning liquid (sauce) used in the present invention is a liquid seasoned with flavorings, such as soy sauce, sake, sweet sake, oyster sauce, edible salt, pepper and the like, and made viscous, for instance, with starch, etc. It is important that the viscosity of the seasoning liquid at 70° C. measured with a C-type viscometer be 1000 to 8000 cP. More preferably, the viscosity is 1500 to 5000 cP. When the viscosity is lower than 1000 cP, the water in the seasoning liquid easily penetrates into the main food when the seasoning liquid is inserted into the container, and when the frozen food is thermally thawed in a microwave oven. Moreover, the seasoning liquid and the main food are not entwined with each other, and the feeling of eating (the texture) of the main food and the taste thereof are not preferable. When the viscosity is higher than 8000 cP, the seasoning liquid becomes too viscous, and the insertion ability thereof with respect to the container is low. In addition, the fluidity of the seasoning liquid is inferior during the thawing thereof in the microwave oven and the like. Therefore, the entwining performance and the like of the seasoning liquid with respect to the main food is low, and the external appearance and taste of the thawed food are undesirable. Therefore, it is also important in the present invention that the seasoning liquid and main food be not wholly but only partially in contact each other.

The main food referred to in the present invention is not particularly limited, so long as the feeling of eating (the texture) of the main food is maintained even after the seasoning liquid is arranged. For instance, it may be rice, noodles, and deep-fried foods and those compound goods and finished goods.

Although in the present invention, the relationship between the seasoning liquid and the main food will be mainly described, it is also possible to insert additional ingredients between the seasoning liquid and the main food. Further the seasoning liquid and the additional ingredients can be mixed. The ingredients are not specially limited. Ingredients the cut shapes of which can be design comparatively freely, such as beef, pork, Chinese cabbage, cabbage, and the like can easily be inserted between and cover the opposed surfaces of the seasoning liquid and the main food. The presence of such additional ingredients is preferred, since they have an effect in controlling or preventing the migration of water from the seasoning liquid to the main food, during the manufacturing of the frozen food, during the safekeeping of the frozen food in a frozen state, and during the thermal cooking of the frozen food.

The frozen food of the present invention is frozen in the container in a state such that the seasoning liquid is placed at the lowest bottom area of the container and the main food is on top of the seasoning liquid. When the container has a single-stage depth, i.e., a single inside bottom surface which is flat, the liquid seasoning is simply placed at the bottom of the container, i.e., on the inside bottom surface, and the main food is placed on top of the seasoning liquid.

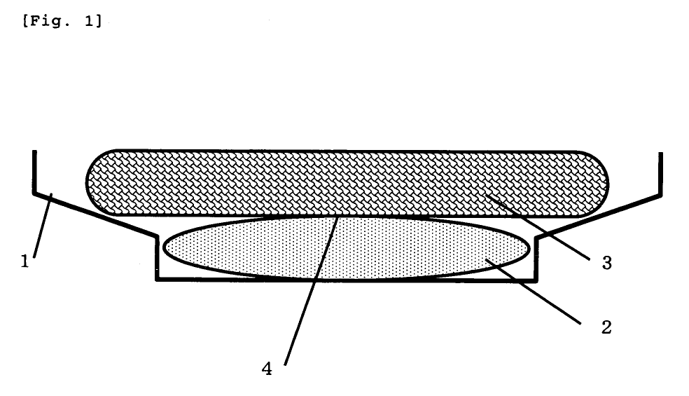

When the container has a two-step depth level, the container has a bottom inner surface which is not completely flat but instead has raised portions, and the seasoning liquid is preferably in contact with the lowest portion of the inside bottom surface of the container. In FIG. 1, reference numeral 1 represents a container with a two-stage depth, reference numeral 2 represents the seasoning liquid, and reference numeral 3 represents the main food. Thus, FIG. 1 depicts a preferred embodiment in which the container has a two-step depth level, and the seasoning liquid is preferably in contact with the lowest portion of the inside bottom surface of the container. When using such a container with a two-step depth, the main food is preferably in contact with a portion of the inside bottom surface of the container which is above the level of the seasoning liquid in the container. Thus, the FIG. 1 also depicts a preferred embodiment in which the container has a two-step depth level, and the main food is preferably in contact with a portion of the inside bottom surface of the container which is above the level of the seasoning liquid in the container.

In FIG. 1, reference numeral 4 represents that portion of the bottom surface of the main food at which the seasoning liquid and main food are in contact. Thus, FIG. 1 also depicts a preferred embodiment in which the total bottom surface area of the main food is larger that that portion of the bottom surface of the main food at which the seasoning liquid and main food are in contact.

In FIG. 1, the two levels of depth of the container are achieved by the use of a container with a particular bottom contour. However, it is to be understood that other containers which have a two-stage depth may also be used. For example, a container with raised ribs on the inside bottom surface may alternatively be used. Moreover, the container may have a three- or greater-stage depth

According to the present invention, the frozen food is eaten after the food is thermally cooked in a microwave oven and the like and can be reversed (inverted) inclusive of the container onto a dish. Inversion of the thawed/cooked food, results in an inversion of the relative positions of the seasoning liquid and the main food, such that the seasoning liquid is now on top of the food rather than beneath the main food. When the area of the bottom surface (as frozen in the container) of the main food is larger than the area of the portions at which the seasoning liquid and the main food contact each other, the condition of the main food as naturally dressed with the seasoning liquid can be reproduced upon inversion of the thawed/cooked food, so that a handmade look can be given thereto. Since the area of the bottom surface of the main food is larger than that of the upper surface of the seasoning liquid, the food achieves the effect of suppressing or delaying the progress of the migration of water from the seasoning liquid to the main food at the portion of the main food which is close to an outer circumference thereof or otherwise not in direct contact with the seasoning liquid. Therefore, after the frozen food is thawed for cooking the same, the taste thereof becomes excellent, so that such preferable results are obtained.

It is necessary that the container used in the present invention be made of a material which permits the container to be used on a microwave oven, in an oven toaster, a conventional oven, a convection oven, on a stovetop, and the like. Especially, in a thermal cooking operation carried out in a microwave oven, the suppression of water migration is noticeably achieved, so that it is preferable that the material for the container be a material which permits the container to be used excellently in a microwave oven. Further, as noted above, the container preferably has a two-step depth.

Other features of the invention will become apparent in the course of the following descriptions of exemplary embodiments which are given for illustration of the invention and are not intended to be limiting thereof. In the present invention, “%” means “″wt%” unless any special notice is given.

### EXAMPLES

### Embodiment 1

Influence of the Viscosity of the Seasoning Liquid upon the Suppression of Migration of the Water of a Chow Mein Dressed with Liquid Starch and the External Appearance of the Product.

Preparation of Chow Mein Dressed with Liquid Starch

1) Seasonings (a total of 9.5% of edible salt, sodium glutamate, spice, concentrated soy sauce, Japanese sake, and sugar and a total of 11.5% of oils, such as soybean oil, sesame oil, and La-oil) and 34.0% of water were heated and mixed with one another. When the temperature of the liquid reached 80° C., 45% of a starch solution the concentration of which was varied from 5.0 to 15.0%, which was obtained by dissolving starch ((“Southern Tokachi Starch”) manufactured by the Federation of the Southern Tokachi Agricultural Product Processing Agricultural Cooperative Association] in the water and controlling the concentration of the solution from 5.0 to 15.0% was added to the mixture, and further heated and mixed with each other so that the viscosity at 70° C. of the resultant mixture reached 500 to 10000 cP measured with a C-type viscometer, to prepare a seasoning liquid.

2) 10 g of peeled shrimps, 10 g of cuttlefish (cut to about 30 mm in longer dimension x about 20 mm in shorter dimension), 40 g of Chinese cabbage (cut to about 60 mm in longer dimension x about 35 mm in shorter dimension), 10 g of carrot (cut to about 30 mm in longer dimension x about 20 mm in shorter dimension X about 3 mm in thickness), 25 g of bamboo shoot (cut to about 60 mm in longer dimension x about 40 mm in shorter dimension x about 5 mm in thickness) and 5 g of Jew's-ear (about 30 mm in longer dimension x about 30 mm in shorter dimension) were fried with salad oil, to prepare ingredients.

3) 0.4% of powdered kansui and 1.0% of salt were dissolved in 31.6% of water thoroughly, and the mixture obtained was kneaded with 67.0% of flour (medium power flour) to prepare dough, which was then rolled to 1.3 to 1.5 mm in thickness and cut to 2 mm in width with a noodle cutter to prepare raw Chinese noodles. The raw Chinese noodles were heated with steam in a steamer for seven minutes, and thereafter boiled in hot water of not lower than 95° C. for 30 seconds. The noodles were then cooled with cold water of not higher than 5° C. to obtain steamed Chinese noodles. 300 g of the steamed Chinese noodles were fried with salad oil at 180° C. for one minute and 30 seconds to prepare chow mein noodles.

4) 90 g of the seasoning liquid prepare in 1), 90 g of ingredients prepared in 2), and 140 g of chow mein noodles prepared in 3) were inserted in the mentioned order into a tray-functioning container of 170 mm in longer dimension x 170 mm in shorter dimension x 43 mm in height, and the contents of the tray was frozen quickly at −40° C., and the product was preserved at −18° C. for 90 days. The insertion of the seasoning liquid into the container was carried out at a temperature of not higher than 70° C., and the insertion of the chow mein noodles into the container was carried out at a temperature of not higher than 50° C.

Sensory Evaluation.

The Chow Mein Dressed with Liquid Starch which was frozen and preserved was heated in a microwave oven (“NE-J3” manufactured by the Matsushita Electric Co., Ltd.) at 600 W for 6 minutes, and the resultant chow mein inclusive of the container was reversed and put on a dish, i.e., it was inverted onto a dish. The chow mein dressed with liquid starch was subjected to collective sensory evaluation with respect to the appearance of the chow mein as a whole, feeling of eating (the texture) thereof and collective rating thereof.

The sensory evaluation of the chow mein was conducted by 20 trained panelists. Among the words of evaluation, the appearance of the cooked chow mein as a whole refers to the balance of the seasoning liquid and chow mein dressed with liquid starch, and the evaluation was made by using the marks “x” meaning very unpreferable, “Δ” normal, and “o” very preferable. The feeling of eating (the texture) of the chow mein refers to the variation of the feeling of eating (the texture) based on the degree of migration of water from the seasoning liquid to the Chinese noodles, and the evaluation was made by using marks “x” meaning soft and very unpreferable, “Δ” normal, and “o” very preferable. The comprehensive evaluation of the chow mein dressed with liquid starch as a whole means the evaluation of the chow mein with the external appearance and feeling of eating (the texture) thereof included, and the evaluation was made by using marks “x” meaning very unpreferable, “Δ” normal, and “o” very preferable. The parenthesized words included in the column of sensory evaluation table are comments tive evaluation marks. The results of the evaluation are shown in Table 1.

TABLE 1

| | | | Collective |
|---|---|---|---|
| | | Feeling of | evaluation |
| Viscosity (cP) at | Appearance of chow | eating | of chow mein |
| 70° C. of | mein dressed with | (texture) | dressed with |
| seasoning liquid | liquid starch | of noodles | liquid starch |
| 500 | x | x | x |
| | (seasoning liquid, | (Soft) | |
| | ingredients and | | |
| | noodles are united as | | |
| | one) | | |
| 1000 | Δ | Δ | Δ |
| 1500 | ∘ | ∘ | ∘ |
| 2000 | ∘ | ∘ | ∘ |
| 3000 | ∘ | ∘ | ∘ |
| 4000 | ∘ | ∘ | ∘ |
| 5000 | ∘ | ∘ | ∘ |
| 6000 | Δ | ∘ | Δ |
| 7000 | Δ | ∘ | Δ |
| 8000 | Δ | ∘ | Δ |
| 9000 | x | ∘ | x |
| | (the seasoning liquid | | |
| | is dull and | | |
| | unpreferable) | | |
| 10000 | x | ∘ | x |
| | (the seasoning liquid | | |
| | is dull and | | |
| | unpreferable) | | |

As shown in Table 1, the appearance of the cooked chow mein was preferable when the viscosity of the seasoning liquid was 1000 to 8000 cP, and more preferable when the viscosity of the same was 1500 to 5000 cP. The feeling of eating (the texture) of the cooked chow mein was preferable when the viscosity of the seasoning liquid was not lower than 1000 cP, and more preferable when the viscosity of the same was not lower than 1500 cP. In the comprehensive evaluation, the cooked chow mein was preferable when the viscosity of the seasoning liquid was 1000 to 8000 cP, and more preferable when the viscosity of the same was 1500 to 5000 cP.

### Embodiment 2

The influence of the method of preparing frozen chow mein dressed with liquid starch upon the time required for preparing the chow mein, the cost of preparing the same, the feeling of eating (the texture) the same, and the appearance of the same will be described.

Preparation of Chow Mein Dressed with Liquid Starch.

1) Seasonings (a total of 9.5% of salt, sodium glutamate, spice, concentrated soy sauce, Japanese sake, and sugar, and a total of 11.5% of oils, such as soybean oil, sesame oil, La-oil, and the like) and 34.0% of water were heated and mixed with one another. When the temperature of the liquid reached 80° C., 45% of starch solution, the concentration of which was regulated to 8.0%, and which was obtained by dissolving starch (“Southern Tokachi Starch” manufactured by the Federation of the Southern Tokachi Agricultural Product Processing Agricultural Cooperative Association) in the water and regulating the concentration of the solution to 8.0% was added to the mixture, and heated and mixed with each other so that the viscosity at 70° C. of the resultant mixture thereof reached about 2000 cP measured with a C-type, to prepare a seasoning liquid.

2) The ingredients the conditions for which are same with those for the ingredients used in section 2) of Embodiment 1 were used.

3) The chow mein noodles the conditions for which are same with those for the chow mein noodles used in section 3) of Embodiment 1 were used.

4) The seasoning liquid, ingredients and chow mein noodles were inserted into a container in the same manner as shown in Table 2 under “Product/Packaging Mode,” and the resultant product was frozen quickly at −40° C. and preserved at −18° C. for 180 days. The inserting of the seasoning liquid was done at a temperature of not higher than 60° C., and the inserting of the chow mein noodles was done at a temperature of not higher than 60° C.

Sensory Evaluation.

Each of the frozen chow mein in preservation dressed with the liquid starch prepared in 1) and the ingredients of 2) according to the present invention was heated in a microwave oven (“NE-C60” manufactured by the Matsushita Electric Co., Ltd.) at 500W for 6 minutes and 30 seconds, and reversed inclusive of the containers to put the chow mein dressed with liquid starch on dishes. The sensory evaluation of the chow mein was made with respect to the time required to cook the chow mein, the manufacturing cost thereof and the feeling of eating (the texture) and the external appearance thereof. In Comparative Examples 1, 2, and 3, the chow mein was taken out of the packaging materials, and thereafter heated in a microwave oven under the conditions identical with those for the chow mein according to the present invention. A sensory evaluation of the resultant chow mein was then carried.

The sensory evaluation was conducted by 20 trained panelists. Among the words of sensory evaluation, the time required was represented by using the marks “x” meaning very long, “Δ” normal, and “o” very short or fuss-free. The cost was represented by using the marks “x” meaning requiring very high additional cost, “Δ” requiring additional cost, and “o” not requiring additional cost or requiring only a low additional cost. The feeling of eating (the texture) the chow mein refers to the variation of the feeling of eating (the texture) the chow mein based on the degree of migration of water from the seasoning liquid to the chow mein represented by using the marks “x” meaning soft and very unpreferable, “Δ” normal, and “o” very preferable. The external appearance of the chow mein dressed with liquid starch refers to the balance of the seasoning liquid and chow mein dressed with liquid starch, and is represented by using the marks “x” meaning very unpreferable, “Δ” normal, and “o” very preferable. The parenthesized words included in the column of sensory evaluation represent comments given to the relative evaluation marks. The results of the sensory evaluation are reported in Table 2.

TABLE 2

| | | | | Feeling of | |
|---|---|---|---|---|---|
| | | | | eating | |
| No. | Product/Packaging mode | Time | Manufacturing cost | (texture) | External appearance |
| Product 1 of | Liquid starch in which seasoning liquid | ∘ | ∘ | ∘ | ∘ |
| the present | and ingredients are mixed together and | | | | |
| invention | chow mein are inserted in the mentioned | | | | |
| | order in a tray-functioning container, | | | | |
| | and quickly frozen. | | | | |
| Product 2 of | Seasoning liquid, ingredients, and chow | ∘ | ∘ | ∘ | ∘ |
| the present | mein are inserted in the mentioned order | | | (very | |
| invention | in a tray-functioning container, and | | | good) | |
| | quickly frozen | | | | |
| Product 1 of | Chow mein noodles and liquid starch in | ∘ | ∘ | x | x |
| comparative | which seasoning liquid ingredients are | | | (noodles | (chow mein is united as |
| example | mixed together are inserted in a bag type | | | are soft.) | one with seasoning |
| | packaging material, and quickly frozen. | | | | liquid, and external |
| | | | | | appearance is bad.) |
| Product of | Chow mein, film sheet and liquid starch | x | Δ | ∘ | Δ |
| comparative | in which seasoning liquid and | (removing | (additional packaging | | |
| example 2 | ingredients are mixed together are | sheet when | expense becomes | | |
| | insert-in the mentioned order, and | eating takes | necessary.) | | |
| | quickly frozen. | time.) | | | |
| Product of | Chow mein, film sheet, and liquid starch | x | x | ∘ | ∘ |
| comparative | in which seasoning liquid and | (removing | (additional packaging | | |
| example 3 | ingredients are mixed together are | sheet when | expense becomes | | |
| | separately packaged, and quickly frozen. | eating takes | necessary.) | | |
| | | time.) | | | |

As shown in Table 2, the products 1 and 2 according to the present invention were more preferable than those of Comparative Examples 1, 2, and 3, and, especially, the mode of the product 2 according to the present invention was most preferable.

### Embodiment 3

The influence of the Contact Surfaces of the Seasoning Liquid and the Chow Mein Dressed with Liquid Starch upon the Appearance of the Chow Mein as a Whole.

Preparation of Chow Mein Dressed with Liquid Starch.

1) Seasonings (a total of 9.5% of edible salt, sodium glutamate, spice, concentrated soy sauce, Japanese sake, and sugar, and a total of 11.5% of oils, such as soybean oil, sesame oil, La-oil, and the like) and 34.0% of water were heated and mixed with each other. When the temperature of the liquid reached 80° C., 45% of starch solution prepared by dissolving starch (“Southern Tokachi Starch” manufactured by the Federation of the Southern Tokachi Agricultural Product Processing Cooperative Association) in the water, and regulating the concentration to 10.0%, was added to the seasoning mixture. This mixture was further heated and mixed therewith, and regulated so that the viscosity at 70° attained 3000 cP measured with a C-type viscometer, to prepare a seasoning liquid.

2) The ingredients the conditions for which are same with those for the ingredients in part 2) of Embodiment 1 were used.

3) The chow mein noodles the conditions for which are same with those for the chow mein noodles in part 3) of Embodiment 1 were used.

4) The seasoning liquid, ingredients, and chow mein noodles were inserted. in the mentioned order into a tray-functioning container while varying the range of the areas in which the seasoning liquid and chow mein noodles contact each other as shown in Table 3, and the resultant product was frozen quickly at −40° C. and preserved at −18° C. for 270 days. The temperature at the time of the insertion of the seasoning liquid into the container was not higher than 50° C., and the temperature at the time of the insertion of the chow mein noodles into the container was not higher than 70° C.

Evaluation of the External Appearance.

The frozen preserved chow mein dressed with liquid starch of the product 3 according to the present invention and the frozen chow mein of the products of Comparative Examples 4 and 5 were heated on a microwave oven (“NE-J3” manufactured by the Matsushita Electric Co., Ltd.) at 600 W for 6 minutes. Each of the resultant chow mein inclusive of the container was reversed and put on a dish (inverted onto a dish). The sensory evaluation of the chow mein with respect to the appearance (condition of the seasoning liquid put on the chow mein) was conducted.

This evaluation was conducted by 20 trained panelists. The external appearance of the chow mein dressed with liquid starch was evaluated with respect to the condition of the seasoning liquid put on the chow mein noodles by using marks “x” meaning very unpreferable, “Δ” normal, and “o” very preferable. The parenthesized words shown in the column of sensory evaluation represent comments on the evaluation marks. The results of the evaluation are shown in Table 3.

TABLE 3

| Product | Contact surface | Appearance |
|---|---|---|
| Product 3 | area of seasoning liquid | ∘ |
| according to the | portion < area of chow | (layer of seasoning liquid |
| present invention | mein portion | has thick and thin portions, |
| | | and is arranged in a natural |
| | | manner. This layer looks |
| | | naturally made, and is |
| | | preferable.) |
| Product 4 of | Are of seasoning liquid | Δ |
| comparative | portion = area of chow | (seasoning liquid is placed |
| example | mein portion | flat on the noodles, and this |
| | | chow mein is somewhat |
| | | mechanical and looks like |
| | | an industrial product.) |
| Product 5 of | area of seasoning liquid | x |
| comparative | portion > area of chow | (chow mein as a whole is |
| example | mein portion | covered with the seasoning |
| | | liquid so as to be soaked |
| | | therein, and the balance of |
| | | the external appearance of |
| | | the product as a meal is |
| | | bad.) |

As shown in Table 3, it was proven that Product 3 according to the present invention was more preferable than the products of Comparative Examples 4 and 5. In this evaluation, the products of Comparative Examples 4 and 5 are compared with the preferred Product 3 according to the present of invention. Therefore, the marks “x”, “Δ” and “o” are strictly the evaluation marks with respect to the external appearance (the condition of the seasoning liquid put on the chow mein) of the chow mein dressed with liquid starch in this comparison. When the products of Comparative Example 4 and 5 are compared with related art products, it is clear that the former products (the products of Comparative Example 4 and 5) are superior to the latter products with respect to the length of time required to thaw, cook and serve the products, manufacturing cost, feeling of eating (texture) the products, external appearance, etc. These facts are as shown in the evaluation results of Embodiments 1 and 2. In other words, although the products of Comparative Examples 4and 5 are “comparative” examples as compared to the preferred Product 3 according to the present invention, the products of Comparative Examples 4 and 5 fall within the scope of certain embodiments of the present invention and, in that regard, are not comparative examples.

### Embodiment 4

The influence of the Time Required for Reversing (Inverting) the Container upon the External Appearance of the Chow Mein as a Whole.

Preparation of the Chow Mein Dressed with Liquid Starch.

1) Seasonings (a total of 9.5% of edible salt, sodium glutamate, spice, concentrated soy sauce, Japanese sake, and sugar and a total of 11.5% of oils, such as soybean oil, sesame oil, and La-oil) and 34.0% of water were heated and mixed with each other. When the temperature of the liquid reached 80° C., 45% of starch solution prepared by dissolving starch (“Southern Tokachi Starch” manufactured by the Federation of the Southern Tokachi Agricultural Product Processing Agricultural Cooperative Association) in the water and regulating the concentration of the solution to 12.0% was added to the mixture, and heated and mixed with each other so that the viscosity at 70° C. of the resultant mixture attained about 5000 cP measured with a C-type viscometer, to obtain a seasoning liquid.

2) The ingredients the conditions for which are identical with those for those in part 2) of Embodiment 1 were used.

3) The chow mein noodles the conditions for which are identical with those for the chow mein noodles in part 3) of Embodiment 1 were used.

4) The seasoning liquid, ingredients, and chow mein noodles were inserted in the mentioned order into the tray-acting container, frozen at −40° C. quickly, and preserved at −18° C. for 360 days. During this time, the area of the bottom surface of the main food was set larger than that of the portion at which the seasoning liquid and main food contact each other. The temperature at which the seasoning liquid was inserted into the container was not higher than 70° C., and the temperature at which the chow mein noodles were inserted into the container was not higher than 70° C.

Evaluation of the Appearance.

The preserved frozen chow mein dressed with liquid starch was heated in a microwave oven (“NE-J3” manufactured by the Matsushita Electric Co., Ltd.) at 600 W for 6 days. The resultant chow mein inclusive of the container was reversed and put on a dish, to obtain Product 4 of the present invention. The preserved frozen chow mein dressed with liquid starch inclusive of the container was reversed and then heated in a microwave oven under the conditions identical with those for Product 4 according to the present invention. The chow mein dressed with liquid starch thus heated was put on a dish, to obtain the product of Comparative Example 6, which was evaluated with respect to the appearance (condition of the seasoning liquid put on the chow mein).

The evaluation of the external appearance was made in the same manner as in Embodiment 3. The results of the evaluation are shown in Table 4.

TABLE 4

| Product | Cooking method | External appearance |
|---|---|---|
| Product 4 | The product | ∘ |
| according | was cooked, | (the layer of the seasoning liquid has |
| to the | and then | thick and thin portions, and has an |
| present | reversed and | external appearance similar to that of |
| invention | put on a dish. | a handmade product and giving an |
| | | impression that the liquid starch is put |
| | | thereon naturally. Very good.) |
| Product 6 of | The product | ∘ |
| comparative | was reversed | (the layer of the seasoning liquid has |
| example | and then | thick and thin portions and has an |
| | cooked, and | external appearance similar to that of |
| | then put on | a hand-made product and giving an |
| | a dish. | impression that the liquid starch is put |
| | | thereon naturally. Good.) |

Although both Product 4 according to the present invention and the product of Comparative Example 6 had a preferable appearance as shown in Table 4, Product 4 according to the present invention had an external appearance more preferable than the product of Comparative Example 6. In the evaluation in this embodiment, the product of Comparative Example 6 in this embodiment was only compared with Product 4 according to the present invention. Therefore, this evaluation comparison is strictly a comparison concerning the external appearance of the chow mein dressed with liquid starch (condition of the seasoning liquid put on the chow mein) of these products. The product of Comparative Example 6 is superior in comparison with a related art product with respect to the time required to thaw, cook and serve the same, manufacturing cost, feeling of eating (texture) the same, external appearance, etc. as shown in the data on Embodiments 1 and 2. In other words, although the product of Comparative Example 6 is a “comparative” example as compared to the preferred Product 4 according to the present invention, the product of Comparative Example 6 does fall within the scope of certain embodiments of the present invention and, in that regard, is not a comparative example.

### Industrial Applicability

According to the present invention, a frozen food in which the feeling of eating (the texture) of a main food is excellent even after the frozen food is heated and/or cooked can be provided.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A frozen food, comprising a seasoning liquid and a main food, wherein said seasoning liquid and said main food are arranged in a container such that said main food is on top of said seasoning liquid, and wherein said seasoning liquid has a viscosity at 70° C. measured with a C-type viscometer of 1000 to 8000 cP, and wherein said seasoning liquid and said main food are frozen with said seasoning liquid and said main food not wholly but only partially contacting each other.

2. A frozen food according to claim 1, wherein said main food has a bottom surface area and said main food also has portions of said bottom surface area which contact said seasoning liquid, and wherein said bottom surface area of said main food is larger than said portions of said bottom surface which contact said seasoning liquid.

3. A frozen food according to claim 1, wherein said container has at least two levels of depth.

4. A frozen food according to claim 1, wherein said container has two levels of depth.

5. A frozen food according to claim 1, further comprising at least one additional ingredient provided between said seasoning liquid and said main food.

6. A frozen food according to claim 5, wherein said seasoning liquid and said at least one additional ingredient are mixed with each other.

7. A frozen food according to claim 1, wherein said main food is at least one food selected from the group consisting of cooked rice, cooked noodles, and mixtures thereof.

8. A method of manufacturing a frozen food according to claim 1, wherein said method comprises:
(a) inserting a seasoning liquid into a container, to obtain a container containing a seasoning liquid;
(b) inserting a main food into said container containing a seasoning liquid, to obtain a container containing a seasoning liquid and a main food; and
(c) freezing said seasoning liquid and said main food in said container containing a seasoning liquid and a main food.

9. A method according to claim 8, wherein said main food has a bottom surface area and said main food also has portions of said bottom surface area which contact said seasoning liquid, and wherein said bottom surface area of said main food is larger than said portions of said bottom surface which contact said seasoning liquid.

10. A method according to claim 8, wherein said container has at least two levels of depth.

11. A method according to claim 8, wherein said container has two levels of depth.

12. A method according to claim 8, further comprising at least one additional ingredient provided between said seasoning liquid and said main food.

13. A method according to claim 12, wherein said seasoning liquid and said at least one additional ingredient are mixed with each other.

14. A method of preparing a cooked food, said method comprising:
(a) heating a frozen food according to claim 1, while maintaining the arrangement of said frozen food in said container, to obtain a heated food; and
(b) inverting said arrangement of said seasoning liquid and said main food, to obtain a dished up food in which said seasoning liquid is on top of said main food.

15. A method according to claim 14, wherein said main food has a bottom surface area and said main food also has portions of said bottom surface area which contact said seasoning liquid, and wherein said bottom surface area of said main food is larger than said portions of said bottom surface which contact said seasoning liquid.

16. A method according to claim 14, wherein said container has at least two levels of depth.

17. A method according to claim 14, further comprising at least one additional ingredient provided between said seasoning liquid and said main food.

18. A method according to claim 17, wherein said seasoning liquid and said at least one additional ingredient are mixed with each other.

19. A cooked food, wherein said cooked food is prepared by a method comprising:
(a) heating a frozen food according to claim 1, while maintaining the arrangement of said frozen food in said container, to obtain a heated food; and
(b) inverting said arrangement of said seasoning liquid and said main food, to obtain a dished up food in which said seasoning liquid is on top of said main food.

20. A cooked food according to claim 19, wherein said main food has a bottom surface area and said main food also has portions of said bottom surface area which contact said seasoning liquid, and wherein said bottom surface area of said main food is larger than said portions of said bottom surface which contact said seasoning liquid.

21. A cooked food according to claim 19, wherein said container has at least two levels of depth.

22. A cooked food according to claim 19, further comprising at least one additional ingredient provided between said seasoning liquid and said main food.

23. A cooked food according to claim 22 wherein said seasoning liquid and said at least one additional ingredient are mixed with each other.
